(19) United States
(12) Patent Application Publication
(10) Pub. No.: US 2007/0121044 A1
(43) Pub. Date: May 31, 2007

(54) Liquid crystal display device and manufacturing method thereof

(75) Inventors: Kang-Fung Liu, Chu Pei City (TW); Chi-Chang Liao, Tai Nan City (TW); Shie-Chang Jeng, Li Kang Hsiang (TW); Yi-An Sha, Taipei City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu County (TW)

(21) Appl. No.: 11/523,010

(22) Filed: Sep. 19, 2006

(30) Foreign Application Priority Data
Nov. 25, 2005 (TW) 94141553

(51) Int. Cl. G02F 1/1337

(52) U.S. Cl. 349/123

(57) ABSTRACT

A LCD device and a manufacturing method thereof are disclosed. The LCD is characteristic of the electrode layer having no alignment layer disposed thereon. On this structure, the electrode layer of the positive and negative electrodes are adjacent to the liquid crystal molecules in the liquid crystal layer, and the electric field produced therebetween and also the structure for isolating the alignment layer in this region can avoid the disclination of the liquid crystal molecules caused by the transverse electric field produced between the electrodes so as to improve the optical efficiency of the LCD device. The manufacturing steps thereof includes providing a first substrate and a second substrate, forming a second alignment layer and a patterned second electrode layer on the second substrate simultaneously or sequentially, injecting liquid crystal to form a liquid crystal layer, and fabricating to form a liquid crystal display cell.

### BACKGROUND OF THE INVENTION

1. Field of the Invention

The present invention is related to a LCD (liquid crystal display) device and a manufacturing method thereof, and more particularly to a LCD in which an electrode layer has no alignment layer disposed thereon thereby improving a disclination phenomenon of liquid crystal molecules caused by the transverse electric field so as to improve an optical efficiency of the display device.

2. Description of Related Art

As shown in FIG. 1 which is a schematic view of the conventional LCD, a liquid crystal layer 100 is disposed between an upper substrate 101 and a lower substrate 103 and respectively on the two substrates, an upper electrode 107 and a lower electrode 108 are disposed so that when the electrodes are conducted, the liquid crystal layer 100 will produce an electric field to polarize the liquid crystal (LC) therein and the liquid crystal molecules will self produce a polarity deflection. In the liquid crystal layer 100 at a certain depth, as shown in FIG. 1, the polarity deflection degree of the liquid crystal molecules are different so that the back light (not shown) may have different brightness at different viewing angles, and the bigger the viewing angle, the more the variation. This results that the viewing angle is not wide enough.

Generally, there are many methods for convincing the problem described above. One kind of LCD using the IPS (In-Plane Switching) is developed by the Japanese company Hitachi, and because the different polarization angles produced by liquid crystal molecules as described above are disappeared, the problem of insufficient viewing angle of LCD can be improved.

As the conventional IPS-type LCD structure in FIG. 2, the upper half-portion structure includes an upper polarizer 201, an upper substrate 203, an upper electrode 205 and an upper alignment layer 207, and oppositely, the lower half-portion structure of the liquid crystal layer 200 includes an lower polarizer 202, an lower substrate 204, an lower electrode 206 and an lower alignment layer 208. The lower electrode layer on the lower substrate 204 is disposed on the transparent substrate in the display structure in a paired manner (one positive electrode and a negative electrode). After applying voltage to the liquid crystal layer 200, cooperating the electric field produced by the upper and lower electrodes 205, 206 with the upper and the lower alignment layers 207, 208 makes the liquid crystals to be aligned parallel to the substrate so as to improve the problem of low light transmittance caused by the irregular alignment of liquid crystal. Therefore, the viewing angle problem of the IPS-type LCD structure can be solved.

U.S. Pat. No. 6,049,369 discloses an IPS-type LCD structure having two layers of transparent substrates as shown in FIG. 2, wherein the liquid crystal in the coated liquid crystal layer can be aligned parallel to the substrate because of the voltage applied to the paired electrodes thereby controlling the light transmittance of the LCD. Please refer to FIG. 3 which is a schematic view showing the electric field distribution of the liquid crystal layer in the LCD, wherein the lower substrate is shown in a vertical view, the electric field distribution is indicated by the power lines with arrowhead and the IPS is produced by the display electrode 31 and the reference electrode 32. In this LCD, the display signals are constituted by the video signal line 33 and the reference signal line 34, and through applying voltage to the electrodes to make the display electrode 31 being a negative electrode and the reference electrode 32 being a positive electrode, the transverse electric field can be produced between the positive and the negative electrodes for driving the polarization of the liquid crystal molecules in an uniform way so as to avoiding the conventional non-uniform problem.

Although the above-described IPS-type LCD structure may have a uniform liquid crystal alignment by aligning electrodes in parallel, the light transmittance of the conventional IPS-type LCD is still limited by the fringe field. The fringe filed may cause the liquid crystal at the peripherals of the electrodes in the display to have a disclination phenomenon. As shown in FIG. 4 which is a schematic view of the LCD structure, the upper electrode layer 403 and the upper alignment layer 401 are disposed in the upper substrate and the lower alignment layer 402 and the lower electrode 404, which is coated by the lower alignment layer 402, are disposed in the lower substrate. When in the normal white mode, the liquid crystal molecules in the liquid crystal layer 400 may have a polarization phenomenon due to the transverse electric field produced by the upper and the lower electrodes, and because the fringe field produced by the transverse electric field between adjacent electrodes, in the liquid crystal layer, the liquid crystal molecules located at the regions above the electrodes have a lower polarization degree than those at the regions located between the electrodes. Therefore, a non-uniform brightness may be produced in the display causing low optical perforrnance, as shown in FIG. 4, the regions between the electrodes are in a light state and the regions above the electrodes are in a dark state.

### SUMMARY OF THE INVENTION

In view of the non-uniform display state in the conventional LCD owing to the transverse electric field, which is originally used to produce a wider viewing angle, between the electrodes, the present invention discloses a different and novel LCD device and manufacturing process using the alignment layer and electrodes with interlaced patterns for improving the conventional problem.

The present invention provides the manufacturing process of directly printing the electrode on the alignment layer for eliminating the liquid crystal disclination around the electrode. The LCD device includes a first substrate, a second substrate, a second alignment layer, a second electrode layer and a liquid crystal layer between the first substrate and the second substrate, wherein the second electrode layer does not cover the alignment layer so that the second electrode layer is directly adjacent to the liquid crystal molecules in the liquid crystal layer, and the second alignment layer in the region without electrode layer is also adjacent to the liquid crystal layer so that the liquid crystal molecule above the second electrode layer structure will not be directly influenced by the alignment layer, thereby avoiding the liquid crystal molecule disclination caused by the transverse electric field produced between the electrodes so as to improve the optical efficiency of the LCD device.

One embodiment of the structure which features the electrode layer having no alignment layer disposed thereon. The electrode structure having positive and negative electrodes is disposed on an alignment layer so that the liquid crystal above the electrode structure will not be influenced directly by the alignment. The manufacturing steps of this embodiment includes providing a first substrate and a second substrate, forming a second alignment layer on the second substrate, forming a patterned second electrode layer on the second alignment layer, injecting liquid crystal between the first substrate and the second substrate to form a liquid crystal layer, and fabricating to form a liquid crystal display cell.

Another manufacturing process for disclosing the characteristic of the electrode layer having no alignment layer disposed thereon includes steps of providing a first substrate and a second substrate, forming a second alignment layer and a patterned second electrode layer simultaneously or sequentially on the second substrate, wherein the alignment layer is formed in a region on the second substrate outside the interlaced patterned electrode, then injecting liquid crystal to form a liquid crystal layer, and fabricating to form a liquid crystal display cell.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the LCD (liquid crystal display) device in the prior art;

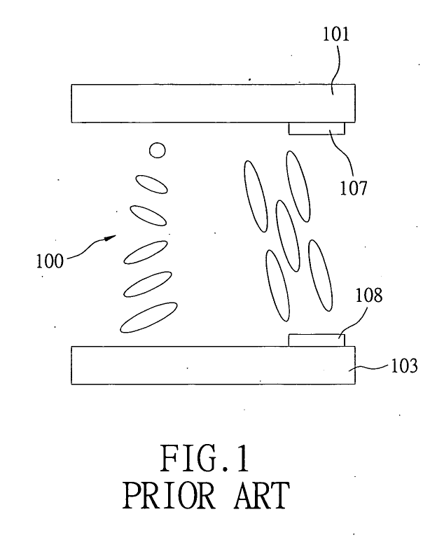

FIG. 2 is a schematic view showing an IPS-type LCD in the prior art;

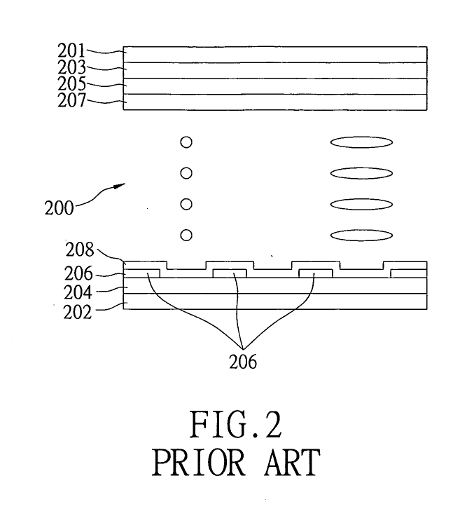

FIG. 3 is a schematic view showing the electric field distribution of the IPS-type liquid crystal layer in the prior art;

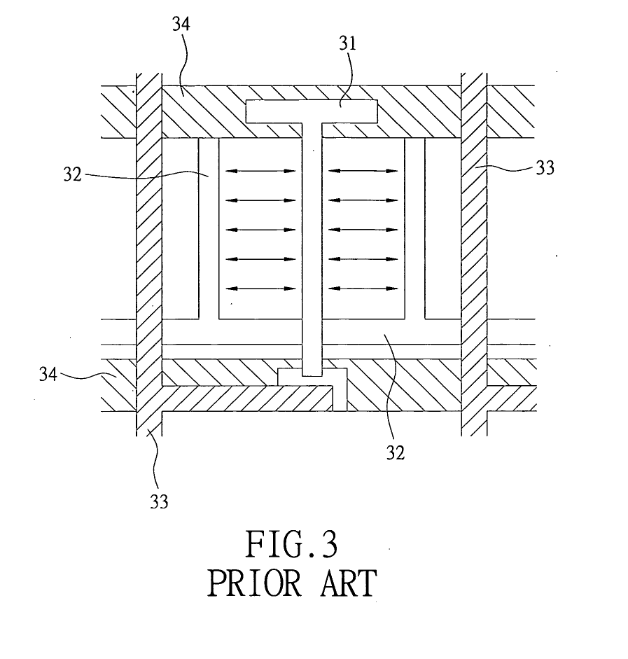

FIG. 4 is a schematic view showing the polarization state of the IPS-type liquid crystal layer in the prior art;

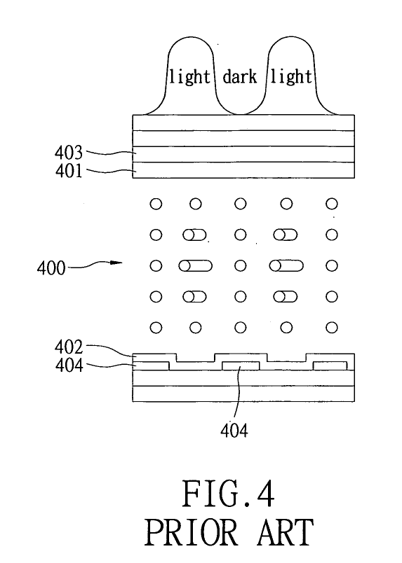

FIG. 5A is a schematic view showing the LCD device in an embodiment according to the present invention;

FIG. 5B is a schematic view showing the LCD device in an embodiment according to the present invention;

FIG. 6 is a vertical view showing the IPS-type electrode in the present invention;

FIG. 7 is a flow chart showing the manufacturing method of an embodiment in the present invention; and

FIG. 8 is a flow chart showing the manufacturing method of another embodiment in the present invention.

### DETAILED DESCRIPTION OF PREFERRED EMBODIMENTS

The present invention discloses a LCD device and a manufacturing method thereof characterized in that the display device structure has no alignment layer disposed on the electrode layer. In one embodiment, the electrode is formed on the alignment layer, and preferably, the IPS-type electrode can be formed on the alignment layer by printing. Accordingly, the electrodes are adjacent to the liquid crystal molecules in structure so that when the liquid crystal molecules are polarized to be aligned toward identical direction owing to the alignment layer, this structure can prevent the liquid crystal molecules from the disclination phenomenon which is caused by the transverse electric field so as to improve the optical efficiency of LCD.

According to another embodiment of the present invention, the alignment layer is formed on the region outside the interlaced patterned electrodes of the substrate structure, namely, the electrode layer is directly adjacent to the liquid crystal layer and not covered on the alignment layer, and thus, the disclination phenomenon of liquid crystal molecules caused by the transverse electric field between the electrodes can be avoided.

In the manufacturing process of the above-described LCD device, the alignment layer and the pattern on the electrode can be formed by printing, which can be an inkjet printing, a flexographic printing, a gravure printing, or a screen printing, or by pressing, which can be achieved by molding or embossing. Through the method described above, the process not only can be simplified but also the material cost and manufacturing time can be saved as compared to the conventional etching method by exposure and lithography.

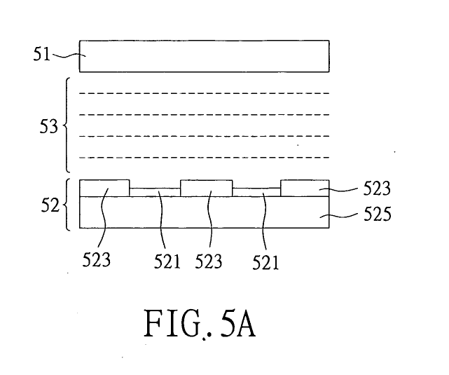

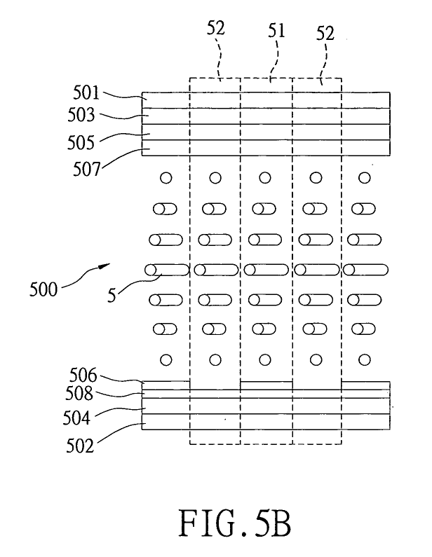

FIG. 5A shows a schematic view of a LCD device according to an embodiment of the present invention. An upper first substrate structure 51, a lower second substrate structure 52 and a liquid crystal layer 53 coated therebetween are included, and further, on the second substrate 525 of the second substrate structure 52, a second alignment layer 521 and a second electrode layer 523 are included. Except the second alignment layer 521 is adjacent to the liquid crystal layer 53, the structure according to the present invention is characterized that the second electrode layer 523 is not covered by the alignment layer, that is to say, the interlaced patterned second electrode layer 523 is also directly adjacent to the liquid crystal layer 53.

The above structure is characteristic of the second electrode layer 523 being not covered by the alignment, wherein the second electrode layer 523 is adjacent to the liquid crystal molecules in the liquid crystal layer 53, the liquid crystal molecules can be polarized by the second electrode layer 523, and the polarization direction thereof can be aligned toward one identical direction by the second alignment layer 521 so that in this structure, the disclination phenomenon of the liquid crystal molecules caused by the transverse electric field between the adjacent electrode structures can be prevented.

For achieving the characteristic of non-covering the second electrode layer 523 by the alignment layer, in one embodiment, the second alignment layer 521 and the second electrode layer 523 can be formed on the second substrate 525 simultaneously or sequentially, for example, by printing.

In another embodiment, the second alignment layer 521 can be formed on the second substrate 525 in advance, and then the interlaced patterned second electrode layer 523 is formed thereon. Through this manner, the characteristic of non-covering the second electrode layer 523 by the alignment layer can be achieved.

Please refer to FIG. 5B which is a schematic view showing the implementation of the LCD device in the present invention, an upper substrate portion (501,503,505,507), a liquid crystal layer 500 and a lower substrate portion (502,504,506,508) are included.

In this embodiment, the first substrate 503 and a first polarizer 501 mounted at one side thereof and adjacent thereto are included in the upper substrate portion, wherein the first polarizer 501 is a light plate which permits only light in one particular direction to pass therethrough. During manufacturing the LCD device, the upper substrate and the lower substrate both have one polarizer disposed respectively therein and mutually interlaced so that depending on the existence of the electric field, the light source may produce a phase difference to cause the light and dark status, thereby displaying words or patterns.

At the other side of the first substrate 503, the first electrode layer 505 and the first alignment layer 507 are formed, wherein the first electrode layer 505 is adjacent to the first substrate 503 and will form an electric field in the liquid crystal layer 500 by cooperating with the second electrode layer 506 in the lower substrate, thereby controlling the polarization angle of the liquid crystal molecules 5. Moreover, the first alignment layer 507 is adjacent to the liquid crystal layer 500 and to the first electrode layer 505 for the purpose of controlling the alignment direction of the liquid crystal molecules 5.

In the lower substrate, a second substrate 504, which is opposite to the first substrate 503, is included, and the second polarizer 502 is disposed at one side of the second substrate 504 and is adjacent to the first substrate 503, wherein the second polarizer 502 is disposed in an interlaced direction to the first polarizer 501 in the first substrate for controlling the phase of light so as to display a light and dark status of the LCD device. The second alignment layer 508 is formed at the other side of the second substrate 504 and a patterned second electrode layer 506 is further formed thereon, wherein the second electrode layer is an IPS-type electrode layer having interlaced positive and negative electrodes.

Then through combining the upper substrate and the lower substrate, the LCD device disclosed in the present invention is formed. Finally, the back light (not shown) transmits the liquid crystal layer 500 to form the light and dark effect. The LCD device according to the present invention can also be applied to color LCD.

Please refer to the structure shown in FIG. 5A, in the second substrate structure, the second electrode layer 523 and the second alignment layer 521 are simultaneously or sequentially formed on the second substrate 525 in an interlaced state, characterized in that the alignment layer is formed in the region outside the interlaced patterned electrode and the second electrode layer 523 and the second alignment layer 521 are both adjacent to the liquid crystal molecules in the liquid crystal layer.

Further refer to the structure of the LCD device in FIG. 5B, the second electrode layer 506 of the lower substrate is disposed on the second alignment layer 508, and the parallel electrode structure of the second electrode layer 506 is adjacent to the liquid crystal molecules 5 of the liquid crystal layer 500 and isolates portions of the second alignment layer 508 that are adjacent to the electrodes so that portions of the second alignment layer 508 that are adjacent to the second electrode layer 506 are not directly adjacent to the liquid crystal molecules 5.

Accordingly, the present invention utilizes the structures in FIGS. 5A and 5B for solving the disclination phenomenon produced by the transverse electric field between parallel electrodes.

In the above description, that's because the liquid crystal molecules above the parallel electrode structure of the IPS-type second electrode layer are not directly influenced by the second alignment layer under the second electrode layer. Please refer FIG. 5B showing the polarization of liquid crystal molecules in region 51, the second alignment layer 508 in this region 51 does not directly influence the alignment direction of the liquid crystal molecules 5 in this region 51. Because liquid crystal is a continuous fluid, under the influence of electric field, the liquid crystal molecules 5 above the parallel electrode (region 51), owing to the liquid crystal molecules 5 at two sides thereof (region 52) being influenced by the electric field to rotate a polarization angle, may also rotate the polarization angle so that the liquid crystal molecules in the liquid crystal layer 500 may have an identical polarization angle, thereby eliminating the disclination produced by the transverse electric field between the parallel electrodes so as to improve the lighting efficiency of the LCD device.

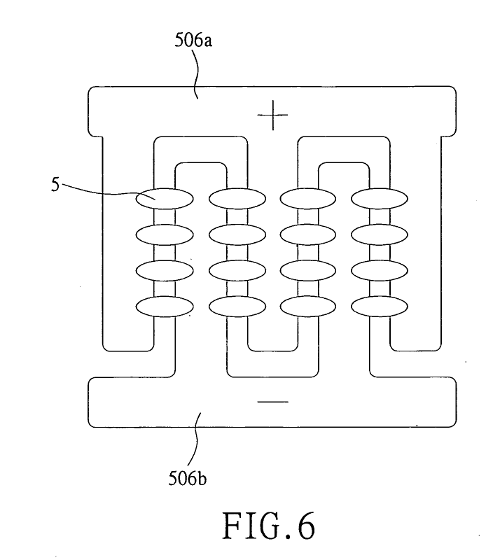

FIG. 6 shows a vertical view of the IPS-type electrode according to the present invention which is also the patterned electrode structure in the lower substrate as shown in FIG. 5A or 5B. The patterned electrode structure includes interlaced positive electrode 506a and negative electrode 506b, and when applying voltage, an electric field will be produced between the positive and negative electrodes so as to drive the liquid crystal molecules 5 to be polarized and aligned in one direction. In the structure disclosed in the present invention, this second electrode layer is disposed on the second alignment layer so that the liquid crystal moles can be adjacent to the positive and negative electrodes and isolates the alignment layer structure relative to this portion.

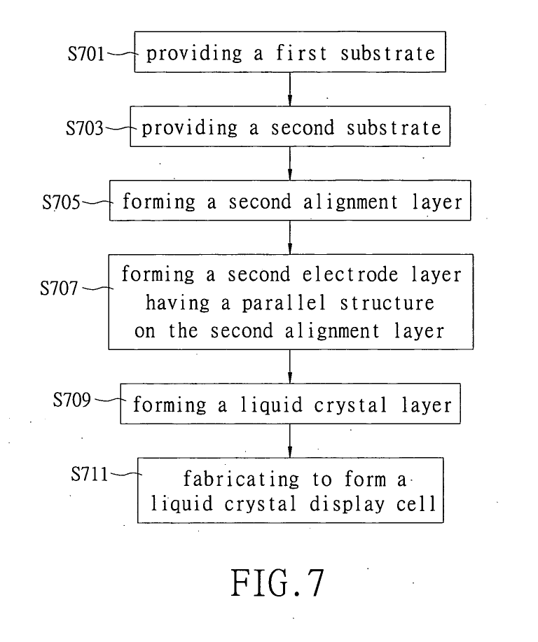

FIG. 7 is a flow chart showing the manufacturing method of the LCD device in the present invention. The manufacturing process of the upper substrate includes providing the first substrate (step S701), and forming relative structures of the first substrate. Then, the structure of the lower substrate is formed, for example, providing the second substrate (step S703), forming the second alignment layer thereon (step S705), forming the patterned second electrode layer having the parallel structure on the second alignment layer (step S707), and finally, injecting liquid crystal between the two substrates to form the liquid crystal layer (step S709) and fabricating to a display cell of the LCD device (step S711).

The electrode layer can be formed by sputtering, pressing or printing, wherein the printing can be an inkjet printing, a flexographic printing, a gravure printing or a screen printing. The alignment layer and the electrode layer can be formed by pressing simultaneously and the liquid crystal layer can be formed by inkjet printing or flexographic printing.

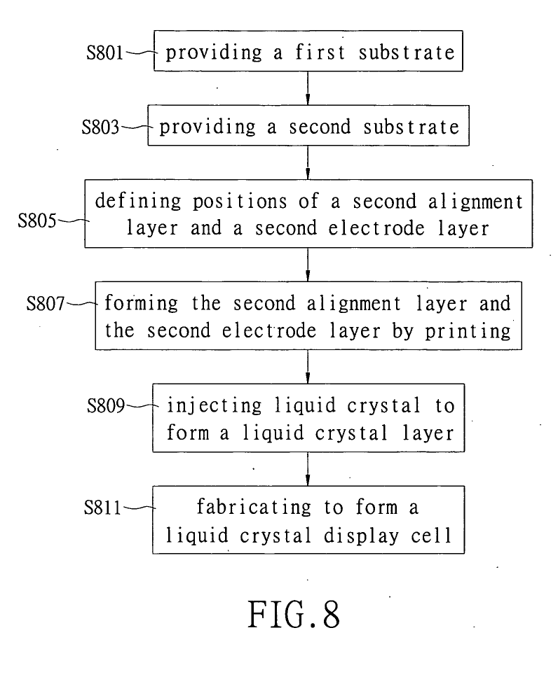

FIG. 8 is a flow chart showing the manufacturing method of the LCD device in another embodiment of the present invention. About the upper substrate, the first substrate is firstly provided (step S801) and a relative structure is formed. Then, the lower substrate is continuously formed, wherein firstly, the second substrate is provided (step S803), the positions of the second electrode layer and the second alignment layer in the lower substrate are defined (step S804), the second alignment layer and the patterned second electrode layer are formed on the second substrate simultaneously or sequentially (step S807), the liquid crystal is injected therebetween to form the liquid crystal layer (step S809) and then a fabrication is performed to form a liquid crystal display cell (step S811).

The drawings of the present invention are only provided for reference and illustration and not for limitation.

In the aforesaid, the LCD device of the present invention forms the electrode on the alignment layer. In structure, the electrode layers of the positive and negative electrodes are adjacent to the liquid crystal molecules in the liquid crystal layer, and the electric field produced therebetween and also the structure for isolating the alignment layer in this region can avoid the disclination of the liquid crystal molecules caused by the transverse electric field produced between the electrodes so as to improve the optical efficiency of the LCD device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate;
a second substrate;
a liquid crystal layer disposed between the first substrate and the second substrate;
a second alignment layer adjacent to the second substrate and the liquid crystal layer; and
a second electrode adjacent to the liquid crystal layer;
wherein the second electrode layer is directly adjacent to the liquid crystal molecules in the liquid crystal layer without any alignment layer structure disposed thereon.

2. The liquid crystal display device as claimed in claim 1, wherein the second electrode layer is an interlaced patterned electrode layer.

3. The liquid crystal display device as claimed in claim 1, wherein the second alignment layer is formed on the second substrate and then the second electrode layer is formed on the second alignment layer.

4. The liquid crystal display device as claimed in claim 1, wherein the second alignment layer is formed on the second substrate and the second electrode layer is formed on region of the second substrate without the alignment layer.

5. A method for fabricating a liquid crystal display device, comprising steps of:
providing a first substrate;
providing a second substrate;
forming a second alignment layer on the second substrate;
forming a patterned second electrode layer on the second alignment layer;
injecting liquid crystals between the first substrate and the second substrate to form a liquid crystal layer; and
fabricating to form a liquid crystal display cell.

6. The method as claimed in claim 5, wherein the second electrode layer is directly adjacent to the liquid crystal layer.

7. The method as claimed in claim 5, wherein the electrode layer is formed by the step of sputtering, pressing or printing.

8. The method as claimed in claim 7, wherein the printing method of the electrode layer is an inkjet printing, a flexographic printing, a gravure printing or a screen printing.

9. The method as claimed in claim 5, wherein the alignment layer is formed by a printing method.

10. The method as claimed in claim 9, wherein the printing method is an inkjet printing, a flexographic printing, a gravure printing or a screen printing.

11. A method for fabricating a liquid crystal display device, comprising steps of:
providing a first substrate;
providing a second substrate;
forming an interlaced patterned electrode on the second substrate;
forming an alignment layer on a region on the second substrate without the interlaced patterned electrode;
injecting liquid crystals between the first substrate and the second substrate to form a liquid crystal layer; and
fabricating to form a liquid crystal display cell.

12. The method as claimed in claim 11, wherein the electrode layer is formed by the step of sputtering, pressing or printing.

13. The method as claimed in claim 12, wherein the printing method of the electrode layer is an inkjet printing, a flexographic printing, a gravure printing or a screen printing.

14. The method as claimed in claim 11, wherein the alignment layer is formed by a printing method.

15. The method as claimed in claim 14, wherein the printing method is an inkjet printing, a flexographic printing, a gravure printing or a screen printing.
